(19) United States
(12) Patent Application Publication
(10) Pub. No.: US 2022/0058553 A1
(43) Pub. Date: Feb. 24, 2022

(54) DETERMINING MEETING ROOM READINESS

(71) Applicant: Lenovo (Singapore) Pte. Ltd., Singapore (SG)

(72) Inventors: Aaron Michael Stewart, Raleigh, NC (US); Ellis Anderson, Greensboro, NC (US); Stephanie Santistevan-Swett, Durham, NC (US)

(21) Appl. No.: 16/999,300

(22) Filed: Aug. 21, 2020

(51) Int. Cl. G06Q 10/06; G06Q 10/10; G06K 9/00; G06K 9/62

(52) U.S. Cl. CPC G06Q 10/06314; G06Q 10/06312; G06K 9/6202; G06K 9/00624; G06Q 10/1095

(57) ABSTRACT

One embodiment provides a method, including: identifying, using at least one sensor, a current condition of a room; determining, using a processor, whether the room is ready for an upcoming meeting based upon the current condition of the room; and performing, based upon the determining, an action. Other aspects are described and claimed.

### BACKGROUND

Entities (e.g., companies, schools, public spaces, etc.) have various types of collaborative spaces available to people within the entity, for example, meeting rooms, auditoriums, classrooms, conference rooms, and the like. Generally people meeting together in these collaborative spaces to brainstorm, work on group projects, discuss different topics, provide presentations, and/or the like. These collaborative spaces often have objects to assist in facilitating the group environment, for example, a conference table with chairs, a whiteboard, writing utensils, paper, and/or the like. Additionally, various types of technology objects including a telephone, video conferencing applications, a projector, a smart display, computers, and/or the like, may be available to the group within the space. Due to limited building space, the collaborative spaces have to be shared among those within the entity, therefor the collaborative spaces often have meetings scheduled one after another.

### BRIEF SUMMARY

In summary, one aspect provides a method, comprising identifying, using at least one sensor, a current condition of a room; determining, using a processor, whether the room is ready for an upcoming meeting based upon the current condition of the room; and performing, based upon the determining, an action.

Another aspect provides an information handling device, comprising: at least one sensor; a processor operatively coupled to the at least one sensor; a memory device that stores instructions executable by the processor to: identify, using the at least one sensor, a current condition of a room; determine, using the processor, whether the room is ready for an upcoming meeting based upon the current condition of the room; and perform, based upon the current condition of the room, an action.

A further aspect provides a product, comprising: a storage device that stores code, the code being executable by a processor and comprising: code that identifies, using at least one sensor, a current condition of a room; code that determines, using a processor, whether the room is ready for an upcoming meeting based upon the current condition of the room; and code that performs, based upon the code that determines, an action.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of determining if a conference room is ready for an upcoming meeting using sensors to identify a current condition of the room.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Offices or other buildings often have a limited number of collaborative spaces or rooms available to host meetings or conferences. For ease of readability, the term meeting room will be used here throughout. However, this is not intended to limit the scope of this disclosure as the term “meeting room” can refer to the traditional conference rooms with a table and chairs arranged around the table, open spaces with rows of chairs, auditorium spaces, or any other spaces groups of people gather to have a meeting, conference, view or provide a presentation, or the like. For ease of readability, the term “meeting” will be used here throughout to refer to the gathering of people within one of the meeting rooms. However, like the term “meeting room”, the term “meeting” is not intended to limit this disclosure to a particular type of group gathering.

When different meetings and meeting attendees are utilizing the same meeting room, it is important to determine if the meeting room is ready for the next meeting before it begins. For example, the number of chairs in the room should match the number of attendees. As another example, the table should be clean and free of debris or forgotten items (e.g., mobile phones, participant notebooks, etc.). As another example, the meeting rooms objects should be clear of any previous meeting materials, for example, a white board or smart board should be cleaned, particularly if confidential material was discussed, notes should be removed, computers should be logged out of, and the like. Often the outgoing meeting participants forget to tidy the meeting room upon leaving.

There is not currently an effective solution for ensuring a meeting room is ready before a meeting starts. People arriving to a meeting room often have to go get additional chairs, wipe off the table, take out the trash, or the like, before they can begin working. This results in a delayed start to the meeting, thereby reducing the amount of working time. Existing solutions require a person to manually inspect the meeting room before a meeting begins to ensure the meeting room is ready for the meeting, for example, by ensuring the table and chairs are cleaned, there are enough chairs for each attendee, any refreshments are ready, the technology is set up for the meeting, or the like. If the person is checking the meeting room before the meeting begins, this results in inefficiencies because it requires the person to take time to walk to and inspect the meeting room before each meeting begins. Additionally, frequently the person inspecting the meeting room is not the person tasked with remedying the undesired condition. For example, an administrative assistant may be the person who inspects the meeting room, but it may be the janitorial staff that cleans the meeting room before a meeting can begin. Additionally, it is difficult for a user to know when a meeting is over and when the user can inspect the room without disturbing a meeting in progress.

Another existing method relies on informal communication or a participant of the next meeting seeing issues with the meeting room. One person leaving a meeting room might tell someone entering the room that some chairs were removed, or the table is dirty. However, these methods are unpredictable with outcomes highly subject to the communication styles and motivation levels of the parties involved. Additionally, just because the new meeting participant knows about the issue does not mean the participant has time to address the issue before the meeting starts, particularly because participants generally arrive to the meeting room near the start time of the meeting. Typically, participants for subsequent meetings make do with the conditions of the room as quickly as possible in order to initiate the planned purpose for the room. Thus, undesirable conditions like improper chair count, a dirty table, forgotten objects, and the like, may go uncommunicated or worsen over time.

Accordingly, an embodiment provides a system and method for determining if a meeting room is ready for an upcoming meeting using sensors to identify a current condition of the room. In an embodiment, one or more sensors are used to identify a current condition of a room. For example, an image capture device may be used to take a picture of the room. As another example, electronic tags may be used to identify objects that are currently in the meeting room. Based upon the current condition of the room, the system may determine if the room is ready for an upcoming meeting. For example, the system may determine if there are enough chairs in the room, if objects have been left by previous meeting participants, if the room is clean, if all confidential information has been removed, and the like. Based upon determining whether the room is ready for the upcoming meeting, an embodiment may perform an action. For example, the system may notify a subsequent meeting participant whether the room is ready or not. As another example, the system may notify a previous participant that an object belonging to the previous participant was left in the room. As a final example, the system may notify a department that the room needs attention.

The illustrated example embodiments will be best understood by reference to the figures. The following description is intended only by way of example, and simply illustrates certain example embodiments.

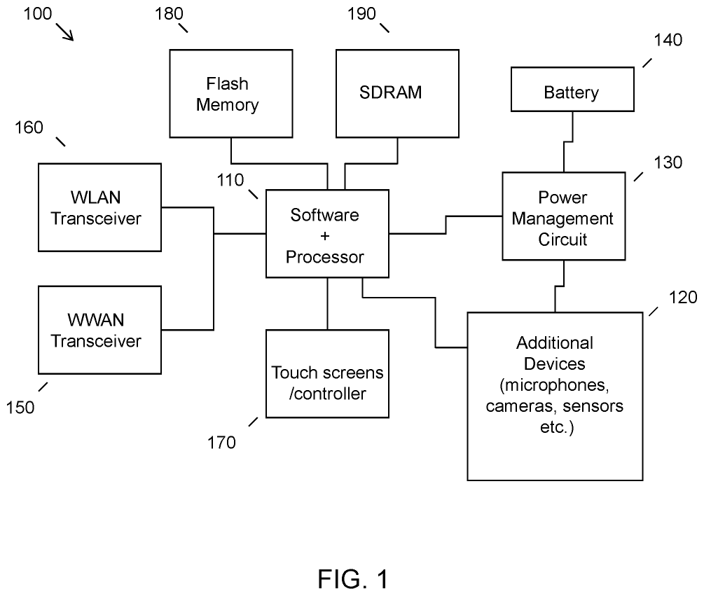

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, buses, I/O ports, etc., as is well known in the art. Internal buses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, etc. System 100 often includes one or more touch screens 170 for data input and display/rendering. System 100 also typically includes various memory devices, for example flash memory 180 and SDRAM 190.

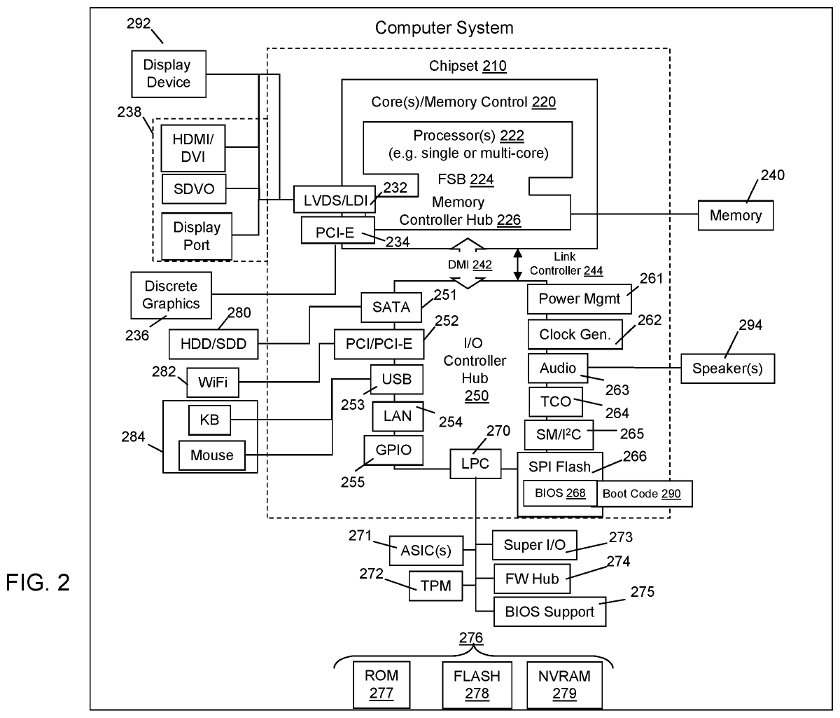

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, buses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling circuitry, as for example outlined in FIG. 1 or FIG. 2, may be used in devices that may be used in meetings, used in meeting rooms, or otherwise support meetings. For example, the circuitry outlined in FIG. 1 may be implemented in a smart phone or tablet embodiment, whereas the circuitry outlined in FIG. 2 may be implemented in a laptop.

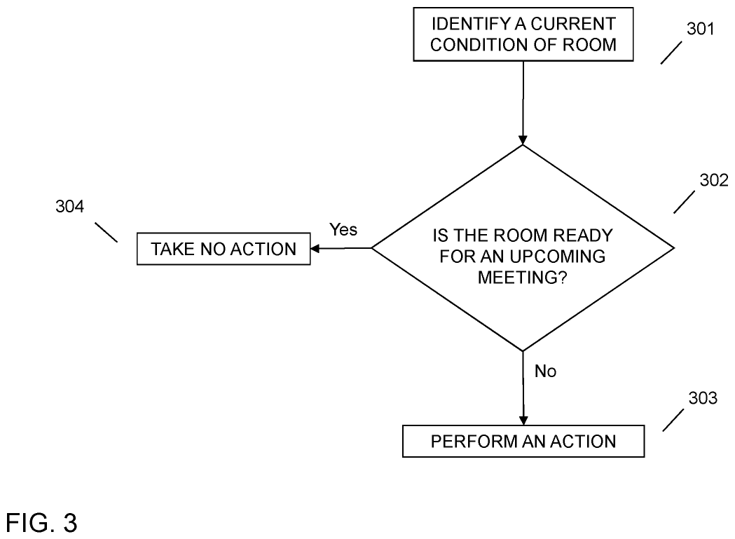

Referring now to FIG. 3, an embodiment provides a method of determining if a meeting room is ready for an upcoming meeting using sensors to identify a current condition of the room. At 301, an embodiment may identify a current condition of a room utilizing one or more sensors. The current condition may be determined at a predetermined time set by a user, a time at which a meeting is scheduled to end, a time at which a meeting actually ends, a set interval before a scheduled ending time of a meeting, a scheduled time after a meeting actually ends, a predetermined time before a meeting is set to begin, at periodic intervals regardless of meeting schedule, upon receipt of a trigger event, or the like. For example, the current condition may be determined at a predetermined interval customizable by the user (e.g., every ten minutes, at set times during the day, etc.). As another example, the current condition may be determined at an identified trigger event (e.g., a time when the last person leaves the room and it is no longer occupied, upon detection of a meeting, upon detection of the door closing or the light being turned off, when a certain person leaves a meeting, etc.).

To identify the current condition of the room, the system may determine what objects are currently in the room. Objects may include physical objects, for example, tables, chairs, pens, pencils, notebooks, projectors, computers, mobile devices, or any other physical objects. Objects may also include digital or non-tangible objects, for example, applications open on a computer, writing on a white board, audio recordings, video recordings, presentations, or any other digital or non-tangible objects. In identifying the current condition of the room, the system may take an accounting of the objects currently within the room, meaning the system not only identifies the objects, but also identifies a quantity of the objects, a user associated with the objects, a device identifier corresponding to the object, or any other information regarding the objects.

Identifying the objects may be performed using one or more sensors. Non-limiting examples of sensors include: image capture devices, audio capture devices, infrared (IR) sensors, temperature sensors, pressure sensors, proximity sensors, object tags, and the like. For example, the system may capture, using an image capture device, at least one image of the room. The system can then use an image analysis technique to parse the image and identify objects found within the image. As another example, the system may utilize an audio capture device to determine if any audio is currently playing or picked up within the room, for example, from an audio recording, people still in the room talking or typing, or the like. If the system does detect audio, the system could use an audio analysis technique to parse the audio to identify a source of the audio, content of the audio, or the like.

As another example, the system may receive communications from objects within the room. For example, each or some of the objects within the room may have tags or sensors attached to or associated with the object. These tags may be programmed to send information to the system. For example, the tags may send identification information, user information, room information or the like. As an example, a tag may be attached to each chair that is assigned to the room. The tag may not only send information identifying it as a chair sensor, but may also send information identifying which room the chair is assigned to. The tags may be near field communication tags, short range communication tags, network tags, or the like.

Other objects within the room may already have the capability to communicate with the system without requiring a tag, although the object may also be tagged. For example, objects with processing capabilities may be able to communicate directly with the system without requiring a special tag. These objects can then send information to the system identifying itself. As an example, a smart phone may send information to the system identifying a user corresponding to the smart phone. As another example, a smart board may communication information about itself, such as whether there is an application open on the smart board, whether all the smart board writing utensils are in the correct location, whether there is any digital writing on the smart board, and the like.

Receipt of information from the one or more sensors may be responsive to the sensors receiving a request from the system. Additionally, or alternatively, the sensors may always transmit information and the system can choose when to listen to the information or ignore the information. A combination of these may also be possible and may be dependent on the capabilities of the sensor utilized. For example, a tag may only transmit information on request because the tag receives its power from the requesting signal. As another example, a smart phone may continuously transmit information regarding a device identifier, but may only provide additional information regarding the device, for example, an associated user, upon request by the system. For example, the system may recognize that the smart phone does not belong in the room, so may request additional information from the smart phone to determine where it should be. As a final example, a smart board may be part of the system and may, therefore, be in constant communication with the system.

At 302, an embodiment may determine whether the room is ready for an upcoming meeting based upon the current condition of the room. To determine if the room is ready for an upcoming meeting the system may utilize the information regarding the objects obtained at 301. For example, since the system has determined what objects are contained within the room, the system can determine whether those objects should be in the room and if any objects that should be in the room are missing. One technique for performing this determination is to compare the identified objects with a list or other information associated with the room that identifies what should be included in the room.

For example, the system may have a list for a room that identifies that the room includes six chairs. If the object information received at 301 identifies that only five chairs are in the room, the system may determine the room is not ready for the next meeting. As another example, the system may determine that object information received includes an object that is not associated with the room, for example, a notebook, smart phone, laptop, pen, or the like, left by a previous meeting participant. This would also indicate that the room is not ready for the next meeting. As another example, the system may determine that there is writing on a display board, or that there is confidential information displayed in the room, and may then determine the room is not ready.

Another technique for determining if the meeting room is ready is to compare the current condition of the room to a baseline condition of the room. The system may store a baseline condition of the room, for example, as an image, an object list, or the like. The baseline condition may be set at a predetermined time set by a user, at periodic intervals, or the like. Upon identifying the current condition of the room at 301, the system may compare this current condition to the baseline condition.

For example, the system may utilize an image capture device to take an initial picture of the room to establish a baseline appearance for the meeting room. When the system later takes a picture of the current room condition, the system can compare the current condition picture to the baseline picture to determine if the room's current condition matches the baseline appearance. As another example, the system may track the number and/or positions of chairs in the room and establish a baseline condition for how many chairs and locations within the room where the chairs should be arranged. When the system obtains the current condition, the system can compare the current position and/or number of chairs to the baseline information to determine if the room is ready for an upcoming meeting. Thus, determining whether the room is ready can be based upon determining or identifying a mismatch or difference between the current condition and the baseline condition of the room.

The system may also determine that, while the information does not match the information associated with the room, the scheduled meeting can occur without changes to the room. For example, if the system determines that there will only be five participants in the next meeting and there are only five chairs instead of the normal six, the system may determine that there will still be enough chairs for the meeting participants. To make such a determination, the system may access information corresponding to the upcoming meeting to make the determination of whether the room is ready in view of the information for the upcoming meeting. As an example, the system may access a calendar or schedule of the meeting room to identify information regarding the upcoming meeting, for example, number of attendees, starting time of the meeting, the meeting participants, and the like. This information may also provide preferences of the meeting participants. For example, one participant may like to write with blue markers on the white board, so regardless of the colors and numbers of markers that should be in the meeting room, if the meeting room contains at least one blue marker, the system may determine the room is ready for the upcoming meeting.

The system may be customized to determine which criteria need to be met for a room to be ready for an upcoming meeting. For example, an embodiment may count the number of chairs and compare it to the expected number of attendees at an upcoming meeting, and find the room is not ready if the number of chairs is less than the expected number of attendees. As another example, an embodiment may determine the room is not ready if people are still present from the former meeting. As a final example, an embodiment may determine the room is ready when all attendees from the previous meeting have left the room, the table has been cleaned, no extraneous objects remain in the meeting room, the trash has been emptied, and/or the display board has been cleared.

If the system determines that the meeting room is ready for the upcoming meeting at 302, the system may take no action at 304. Alternatively, the system may send a notification to an upcoming meeting participant, a designated user, or the like, notifying them that the meeting room is ready for the upcoming meeting. The system may also change a status associated with the room in a system. For example, schedule for the meeting room may show that the meeting room has been checked and is ready for the upcoming meeting. As another example, the room may have an associated display outside the room that can be changed to “Ready” or some other identifier.

On the other hand, if the system determines that the room is not ready for the upcoming meeting at 302, the system may perform an action at 303. The action may include notifying at least one user of the room status, updating a status in an application, changing a display to indicate the room is not ready, or the like. The system can be customized to notify different users depending on which conditions need attention. For example, the leader of an upcoming meeting may be notified the room is not yet available because the previous meeting has run over time and the room is still occupied. The leader of a current meeting may be prompted to end the meeting and leave the room because the scheduled time has lapsed. As another example, if the room requires cleaning, a designated person can be notified to clean the room. As another example, if more chairs are needed, a facilities manager can be notified to bring more chairs from another location. As a further example, if a smartboard was not erased, a copy of the contents can be sent to the leader of the previous meeting, and then the display can be automatically reset for the upcoming meeting. As a final example, if the system determines extraneous objects have been left in the meeting room, the system may message the previous attendees to pick up their belongings.

Alternatively, or additionally, the meeting room status may be available in an application. Users may open an application to see a list of meeting rooms displayed with indicators if the rooms are ready or not ready. The application may also list the outstanding conditions waiting to be remedied. For example, the application may indicate a certain meeting room requires cleaning before it can be moved to ready status. The application may indicate the room has been cleaned, but extraneous belongings have not been removed. The application could indicate a room has enough chairs, but the table is dirty. The meeting leader could choose to overlook the not ready indicator and proceed with the meeting if the leader is not concerned about the outstanding conditions.

Alternatively, or additionally, a display could be located outside of the meeting room, at a central location such as a reception desk, or at any other convenient location. The system may change the display to visually indicate if the status of a meeting room is ready or not ready. If an office has multiple meeting rooms, the display could quickly summarize which rooms are available and ready to host an upcoming meeting. In some situations the meeting leader may wish to move the meeting to an open room instead of waiting for the scheduled room to open up or become ready.

The following is a list of example scenarios to which the foregoing embodiments may be applied. It is important to note that these scenarios are non-limiting and that the embodiments described herein may be applicable to other scenarios not explicitly described here.

In one example, objects in the meeting space are tracked using the one or more sensors. For example, sensors can track the number and/or locations of chairs in the meeting space. The system may calculate the number of chairs required for an upcoming meeting, and take an action based on whether the actual number of chairs in the room meets the required number of chairs. If there are not enough chairs detected in the room, the system could notify a specific person tasked with arranging the meeting room to find additional chairs, such as an administrative assistant, janitorial staff, or facilities manager. If any chairs are detected out of position, the system may notify the cleaning staff to straighten up the positioning of the chairs before the room is determined to be ready. The system may determine the room is ready after the number of chairs matches the number of attendees at the upcoming meeting.

As another example, the system may track the number of people currently in a meeting space. The system may track the number of people directly, for example, by using IR sensors to detect heat signatures, using a camera to count the number of people in the meeting space, using a motion sensor to determine when a door is opened or closed, identifying cell phones or laptops and using those as a proxy for the number of people in the space, or the like. For example, if six cell phones are detected in the space, the system may assume there are six users present. The system may use data from cell phones to identify users in the room, or the system may use data from a scheduling application to determine the identities of the meeting participants. The system may track ID badges or use RFID tags to identify the number and/or names of people in the meeting space. The system may track the number or identities of people in the meeting space to determine at which time the last person left the meeting room.

Additional types of objects can be tracked using sensors. For example, a whiteboard, chalkboard, smart screen or other display may be tracked and a notification sent to a user if the display was not erased at the end of the meeting. This step is important because the displays can include confidential material. In an embodiment the system automatically prompts one or more users before a meeting ends to erase the displays. In another embodiment the system notifies one or more users after a meeting ends that the displays must be cleaned before a new meeting can begin. In another embodiment the system sends a copy of the displayed information to a designated user and then erases the display.

The system can also track users' belongings. The system can determine a new object has been left in the meeting room. For example, attendees may forget to take cell phones, laptops, coffee cups, pencils, books, folders, or other personal belongings. The system may email or text attendees of the previous meeting to return and pick up the personal belongings. In another embodiment, the system prompts users before the meeting ends to remove all the personal belongings. The system may determine unknown objects have entered the meeting room, and prompt users to remove the unknown objects before the meeting ends. The system may track food delivery, and notify a designated user when the trash can is full, or coffee cups and food items remain in the meeting room.

Notification of users may be by email, text, usage of internal company messaging systems, or other messaging applications. The system may identify a meeting leader or other responsible party of an upcoming meeting and preemptively notify that user if the currently scheduled meeting is going past its scheduled end time. The system may change a room status to not ready and notify a responsible person if the number of chairs is not adequate for an upcoming meeting, if the table needs cleaned, or if any required object is missing from the meeting space. The system may create a service ticket to automatically notify cleaning staff, a facilities manager, or other person tasked with cleaning of conditions that need attention. These conditions may include missing chairs, extra objects in the room, a dirty display, dishes, garbage, objects have been taken out of the room, a dirty table top, or other undesirable conditions.

The system may also determine a room is not ready for an upcoming meeting because necessary objects are not in the room. For example, a presenter may require a projector to give a presentation. If the system determines the projector is missing, the room status may be set to not ready and a notification sent to the responsible person to set up a projector. After the projector is set up, the system may change the room status to ready.

The various embodiments described herein thus represent a technical improvement to conventional methods of determining if a meeting room is ready for a meeting to begin. Using these techniques, an embodiment may make it easier for users to know when a meeting room is ready for an upcoming meeting to begin. Automatically notifying users of the status of a meeting room saves time and improves efficiency.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
identifying, using at least one sensor, a current condition of a room;
determining, using a processor, whether the room is ready for an upcoming meeting based upon the current condition of the room; and
performing, based upon the determining, an action.

2. The method of claim 1, wherein the identifying comprises capturing at least one image of the room.

3. The method of claim 1, wherein the identifying comprises receiving communication data from objects within the room.

4. The method of claim 1, wherein the identifying comprises identifying objects currently within the room.

5. The method of claim 1, wherein the determining comprises comparing the current condition of the room to a baseline condition of the room.

6. The method of claim 5, wherein the determining comprises identifying at least one difference between the current condition of the room and the baseline condition of the room.

7. The method of claim 1, wherein the determining comprises accessing information corresponding to the upcoming meeting and performing the determining in view of the information corresponding to the upcoming meeting.

8. The method of claim 1, wherein the performing an action comprises sending a notification to at least one user regarding the current condition of the room.

9. The method of claim 8, wherein the at least one user is selected from the group consisting of: an attendee of the upcoming meeting, an attendee of a meeting previously held in the room, and a person tasked with managing a condition of the room.

10. The method of claim 1, wherein the identifying is performed responsive to receiving a trigger event.

11. An information handling device, comprising:
at least one sensor;
a processor operatively coupled to the at least one sensor;
a memory device that stores instructions executable by the processor to:
identify, using the at least one sensor, a current condition of a room;
determine, using the processor, whether the room is ready for an upcoming meeting based upon the current condition of the room; and
perform, based upon the current condition of the room, an action.

12. The information handling device of claim 11, wherein the instructions executable by the processor to identify comprises instructions executable by the processor to capture at least one image of the room.

13. The information handling device of claim 11, wherein instructions executable by the processor to identify comprises instructions executable by the processor to receive communication data from objects within the room.

14. The information handling device of claim 11, wherein the instructions executable by the processor to identify comprises instructions executable by the processor to identify objects currently within the room.

15. The information handling device of claim 11, wherein the instructions executable by the processor to determine comprises instructions executable by the processor to compare the current condition of the room to a baseline condition of the room.

16. The information handling device of claim 15, wherein the instructions executable by the processor to determine further comprise instructions executable by the processor to identify at least one difference between the current condition of the room and the baseline condition of the room.

17. The information handling device of claim 11, wherein the instructions executable by the process to determine comprises instructions executable by the processor to access information corresponding to the upcoming meeting and perform the determining in view of the information corresponding to the upcoming meeting.

18. The information handling device of claim 11, wherein the instructions executable by the processor to perform an action comprise instructions executable by the processor to send a notification to at least one user regarding the current condition of the room

19. The information handling device of claim 11, wherein the instructions executable by the processor to identify is performed responsive to receiving a trigger event.

20. A product, comprising:
a storage device that stores code, the code being executable by a processor and comprising:
code that identifies, using at least one sensor, a current condition of a room;
code that determines, using a processor, whether the room is ready for an upcoming meeting based upon the current condition of the room; and
code that performs, based upon the code that determines, an action.
